(19) United States
(12) Patent Application Publication
(10) Pub. No.: US 2023/0076393 A1
(43) Pub. Date: Mar. 9, 2023

(54) HASHING METHODS AND SYSTEMS

(71) Applicant: Optalysys Limited, Leeds (GB)

(72) Inventors: Edward COTTLE, Leeds (GB); Nicholas James NEW, Pontefract (GB)

(21) Appl. No.: 17/759,746

(22) PCT Filed: Jan. 29, 2021
(86) PCT No.: PCT/GB2021/050214

§ 371 Date: Jul. 29, 2022

(30) Foreign Application Priority Data
Jan. 31, 2020 (GB) 2001382.7

(51) Int. Cl. G06F 17/16; G06F 17/14

(52) U.S. Cl. CPC G06F 17/16; G06F 17/141

(57) ABSTRACT

A hashing method comprises the steps of converting an input message into a binary input matrix with columns and rows; applying a Fourier Transform (FT) to obtain a multiplication; wherein said FT is an optical FT; and applying a summation across the rows.

### TECHNICAL FIELD

The invention generally relates to hashing methods and systems for hashing.

### BACKGROUND AND PRIOR ART KNOWN TO THE APPLICANT(S)

The SWIFFT collection of compression functions [Vadim Lyubashevsky, Daniele Micciancio, Chris Peikert, and Alon Rosen. Swifft: A modest proposal for fft hashing. In Kaisa Nyberg, editor, Fast Software Encryption, pages 54-72, Berlin, Heidelberg, 2008. Springer Berlin Heidelberg.] is known to support an asymptotic security proof, through which it is possible to show that finding collisions in a randomly chosen function from SWIFFT is at least as hard as finding short vectors in cyclic/ideal lattices in the worst case.

Embodiments of the invention seek to improve on the prior art methodologies.

### SUMMARY OF THE INVENTION

In a first broad independent aspect, the invention provides a hashing method comprising the steps of:

converting an input message into a binary input matrix with columns and rows; multiplying the binary matrix with an integer specific to each row;

applying a Fourier Transform (FT) to obtain Fourier coefficients; wherein said FT is an optical FT; and

applying a linear combination across the rows.

This configuration is particularly advantageous as it may achieve in certain embodiments higher resolutions, increased precision, or enhanced security.

In a subsidiary aspect, said binary input matrix is processed with a look-up table to obtain matrix elements. In preferred embodiments, this pre-processing is electronic and carried out prior to optical processing.

In a further subsidiary aspect, said optical FT is a 2D optical FT which calculates a matrix of Fourier coefficients. This avoids in certain embodiments the need to reconstruct the 2D matrix as compared to 1D implementations.

In a further subsidiary aspect, the method further comprises the step of applying an element wise matrix multiplication in the Fourier domain with an additional matrix of the same size as the binary input matrix.

In a further subsidiary aspect, the method further comprises the step of applying an optical Inverse Fourier Transform (IFT) before said step of applying a summation across rows.

In a further subsidiary aspect, said step of applying a summation is optical.

In a further subsidiary aspect, said converting and multiplication of matrix elements are realised electronically prior to any optical processing. This provides the advantageous integration between electronic and optical system to further enhance the performance.

In a further subsidiary aspect, a look-up table is employed in the multiplication of matrix elements.

In a further subsidiary aspect, each column of said binary matrix is fed in parallel to a single free-space optical FT in order to provide outputs from said optical FT. This configuration is particularly advantageous in term of processing speed.

In a further subsidiary aspect, said outputs are fed into an array of waveguides to represent vectors of Fourier coefficients.

In a further subsidiary aspect, the method further comprises the step of re-stitching the vectors of said Fourier coefficients into columns of a further 2D matrix with columns and rows.

In a further subsidiary aspect, the method further comprises the step of multiplying each row of said further 2D matrix optically, element-wise against a pre-determined vector.

In a further subsidiary aspect, the method further comprises the step of summing across the rows by optical combination of the waveguides that make up each row of said 2D matrix into a single optical signal. This configuration further enhances performance.

In a further subsidiary aspect, the method further comprises the step of realising the electronic conversion of optical output signals to a modulo ρ answer via the use of a look-up table.

In a further subsidiary aspect, the method further comprises the step of normalising the optical outputs by rendering the highest value in the output equal to the highest value in the bit range and applying linear scaling over the other values. This configuration further enhances the method by allowing it to be much less susceptible to the effect of noise.

In a further broad aspect, the invention provides a processing system comprising an electronic processor configured to convert an input message into an integer matrix with columns and rows, and an optical processor configured to calculate a Fourier Transform (FT) to obtain a matrix of Fourier coefficients; wherein said FT is an optical FT; said optical processor being further configured to apply a linear combination across the rows.

In a preferred embodiment, said system is configured to convert said binary matrix into an integer matrix via a lookup table.

In an alternative embodiment, said FT is a Fast Fourier Transform (FFT).

In a further subsidiary aspect, said processing system comprises an electronic processor and an optical processor configured to carry out the hashing methods of any one of the preceding aspects.

### BRIEF DESCRIPTION OF THE FIGURES

FIG. 1 shows a block diagram of an embodiment of the invention.

FIG. 2 shows a system with a reduced number of stages which may still be used to generate a different hash function, based upon not calculating the last OFT stage.

FIG. 3 shows a schematic optical system in accordance with the embodiment of FIG. 1.

FIG. 4 shows a schematic optical system in accordance with the embodiment of FIG. 2.

### DETAILED DESCRIPTION

### General Embodiments

Embodiments provide improvements to the SWIFFT proposals by appropriately employing optical computing hardware.

The algorithm can be broken down into a series of steps as follows (all operations take place over the set of integers modulo a certain value e.g. Zρ where ρ is the modulus):

1. Conversion of the input message into a binary matrix.

2. Multiplication of matrix elements by an integer unique to each row.

3. 1D Fast Fourier Transform (FFT) of matrix columns to calculate vectors of Fourier coefficients.

4. Re-stitching of the Fourier coefficient vectors into columns of a new matrix.

5. A linear combination across each matrix row.

Steps one and two may in certain embodiments be completed electronically via pre-processing in electronics. Item (1) can be achieved by taking the hexadecimal input string and re-addressing the bytes as a 2D array. Item (2) can be achieved via lookup table: values in the binary matrix that are of value 1 are changed via lookup table an integer determined by the row of the matrix, 0 values are untouched from the original matrix.

Steps (3, 4, and 5) can be achieved via specialised optical hardware in various configurations. All columns of the binary matrix are preferably fed in parallel into an optical system that performs a multi-vector parallel 1D Optical Fourier Transform (OFT) in free space via a lens. The output of each OFT is then fed into a 1D array of waveguides, this completes step (3). To complete step (4) the 1D arrays, once in waveguides can now be considered to be columns in a 2D matrix. For step (5), the layout of the OFT outputs is considered in this way. Viewing the data as a 2D matrix, elements from each row can now be modulated to calculate an optical multiplication of each value against some pre-determined vector. After optical multiplication, the waveguides that make up each row of the 2D matrix can be combined into a single optical signal to produce the summation across the row. Multiplying each row of the matrix, then summing across rows (using modulo arithmetic) gives the linear combination of step (5).

Further embodiments of the invention consider the use of an optical free-space computer, to change the algorithm to both potentially strengthen the security of the algorithm and simplify the hardware involved. Instead of having 1D OFT sections that are computed for each column of the input matrix, embodiments of the invention take the 2D OFT of the entire matrix using a single optical free-space section.

This simplifies the hardware by meaning that, in certain embodiments, only a single lens is required per Fourier Transform (FT)/Inverse Fourier Transform (IFT) operation and still only takes (1) time due to the use of optics. The only constraint to the speed of this operation is the speed at which data can be encoded into and read out from the system which could reasonably reach a 40 GHz frame rate.

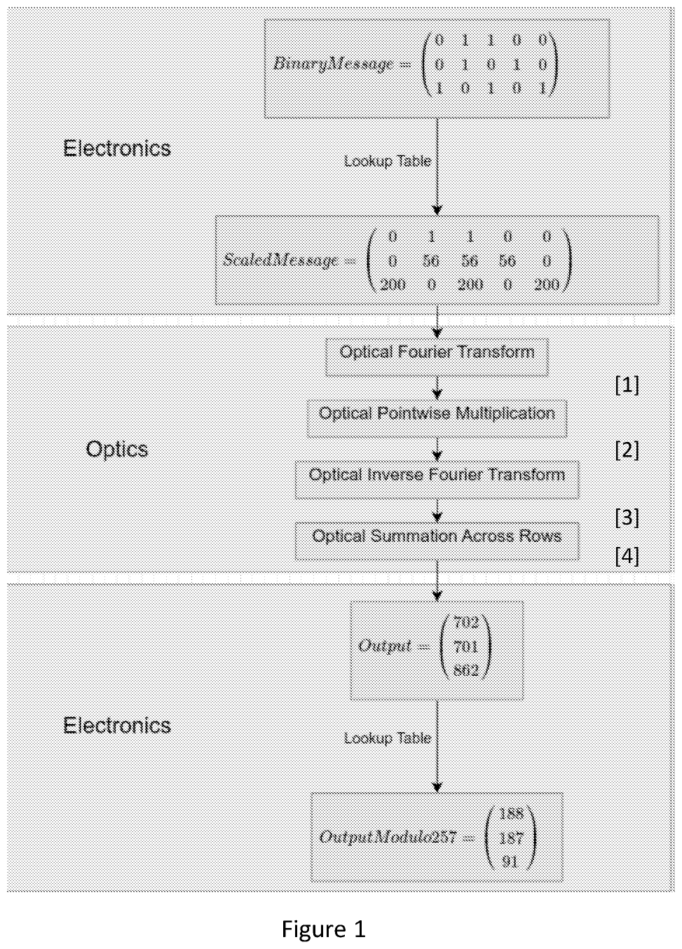

With an electronic processor, a 2D FT on a matrix requires much more computation than one FT per matrix column as in SWIFFT. This is because the electronic FFT has a computational complexity of O(n log n) where n is the length of the vector in the 1D transform or the number of matrix elements in the 2D version. This disadvantage is not present with the OFT which computes in parallel at the speed of light. The use of the 2D transform changes the analogous problem from the Shortest Vector Problem (SVP) in polynomial cyclic lattices to the same problem over multivariate cyclic lattices which is known to have the same NP-hardness. The algorithm optimised for the optics is as follows and represented as a block diagram in FIG. 1:

1. Conversion of the input message into a binary matrix.

2. Multiplication of matrix elements by an integer unique to each row.

3. 2D FFT of matrix to calculate matrix of Fourier coefficients.

4. An element wise matrix multiplication in the Fourier domain.

5. An inverse OFT section.

6. A summation across matrix rows.

Once again steps (1) and (2) are computed in electronic pre-processing via lookup table.

Step (3) is calculated by the 2D OFT via free-space optics. In a preferred embodiment, the new proposed algorithm takes place using a two-dimensional latent representation of the input data and key. This means that when the hashing takes place, the confusion and diffusion steps operate in multinomial rather than polynomial space, making the algorithm more secure, and requiring a new proof of security, independent of the original SWIFFT algorithm. The fact that an optical Fourier transform and multiplication is used changes the algorithmic complexity from O(n log (n)) to O(1). These two facts together provide a greater amount of data obfuscation as well as a reduced runtime (and energy cost) with respect to input/key size.

Step (4) is achieved via element wise matrix multiplication of the OFT result matrix with an additional matrix of the same size. The optical IFT of this output matrix is then taken (to reduce the dominance of the Direct Current (DC) term). As in section 2, the output is preferably summed across rows to output a vector of values that makes up the message digest.

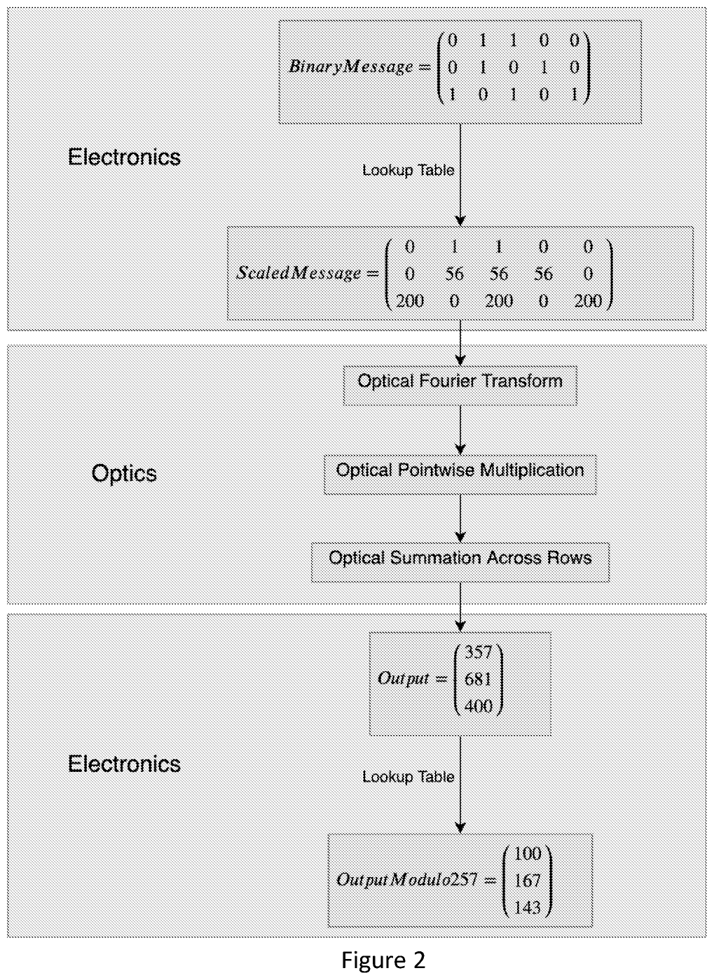

FIG. 2 shows a system with a reduced number of stages which may still be used to generate a different hash function, based upon not calculating the last OFT stage.

Considerations for a Practical Optical System

The use of the OFT means that the output is not of the same scale as an integer implementation in electronics. One of the solutions to this is to consider all output from the optics relative to themselves: outputs are normalised by making the highest value in the output equal to the highest value in the bit range and applying linear scaling over the rest of the values.

A good hash function should be deterministic. The same value needs to be obtained every time the value is calculated in the optical system. The use of the OFT means that the computations are analogue and subject to noise in the system. In other words, the proposed algorithm makes use of a noisy, continuous Fourier transform of the input data which is sampled at discrete intervals. This optical function is mathematically distinct from DFT as proposed in the prior art. The inherent noise in the system, if not appropriately handled, would lead to non-determinism which is highly undesirable for a hashing function. As such a proposed method to increase precision is provided in the application in order to ensure that the output remains consistent.

Making an optical computer that is reliable up to 8-bit output precision is a difficult task. The outputs of the system must be accurate to 8-bit precision for the SWIFFT algorithm, therefore embodiments of the invention provide a software algorithm to get around this hardware limitation. Calculations can be computed on a lower precision machine utilising multiple passes through the system and bit-shifting the result appropriately shown in this case with multiplication, FT operations work in a similar way as it is linear:

154×201=30954=0111100011101010 (1)

To compute with only 8-bits of reliable output:

a=154=10011010

b=201=11001001 (2)

Split to 4-bit inputs so that the output precision is not exceeded:

a1=1001

a2=1010

b1=1100

b2=1001 (3)

Compute Result:

a·b=(a1·b1)<<8+(a1·b2)<<4+(a2·b1)<<4+(a2·b2)

a·b=(9·12)<<8+(9·9)<<4+(10·12)<<4+(10·9)

a·b=108<<8+81<<4+108<<4+90

a·b=27648+1296+1920+90 (4)

A similar method can be used to compute multiplications and FT operations at arbitrary precision on a precision-constrained machine.

As previously mentioned, all operations that take place in SWIFFT are over the set of integers modulo ρ where ρ is a pre-determined value. Each output from the system will fall in the range dictated by the system's precision. E.g. for an 8-bit input and output system, the output will also fall in the 8-bit range. The true values if computed electronically would fall in the 16-bit range, with the maximum possible value equal to 256\hat{ }2−1. The 8-bit outputs of this system represent rounded 16-bit values, as such to get the true value we must multiply them by 256, then calculate modulo ρ. A faster way to achieve the same calculation is to provide a look-up table via which the modulus of the true answer can be fetched without further computation. In an 8-bit machine the size of the lookup table would be only 256 bytes in size. Once the correct answers modulo ρ have been obtained, to sum across rows would be to add all these values together then modulo ρ. This additional computation could be avoided by using an optical summation of matrix rows, followed by a larger lookup table.

A further detailed embodiment of the invention will now be described. The algorithm can be split into two electronic stages with an optical stage in between, as shown in FIG. 1. This algorithm allows for a message to be hashed into a digest, the size of which is dictated by the precision of the calculations and the number of matrix rows on the optical device, e.g. 8-bit precision and 8 rows would give a 64-bit output. The maximum size of the input message in bits is equal to the number of matrix elements representable on the optical device.

First Electronic Stage
Conversion of the input message into a binary matrix. Achieved by reshaping the input message into a binary matrix.
Multiplication of matrix elements by an integer unique to each row. Achieved via lookup table on values in the binary matrix, memory address based on the row.

Optical Stage
2D FFT of matrix to calculate matrix of Fourier coefficients. Utilises the scaling and output precision techniques mentioned previously.
An element wise matrix multiplication in the Fourier domain of the input matrix with a separate matrix of integers.
An inverse OFT section. Other embodiments may not require an optical inverse Fourier Transform which is an optional feature.
A summation across matrix rows. Can either be added in electronics or by combining the optical signals across the matrix rows.

Second Electronic Stage
Conversion from raw output to modulo ρ answer. Achieved via lookup table, address based on the output value.

The optical stage may be realized on any one or a combination of the prior art optical systems which are embodied in any of the following patent applications which are owned by Optalysys Limited:
EP1420322;
WO2018167316;
EP1546838;
U.S. Ser. No. 10/289,151;
U.S. Ser. No. 10/409,084;
WO2019207317.

Each one of these documents is incorporated by reference. The prior art system architectures would be configured to operate the method of various embodiments of the invention.

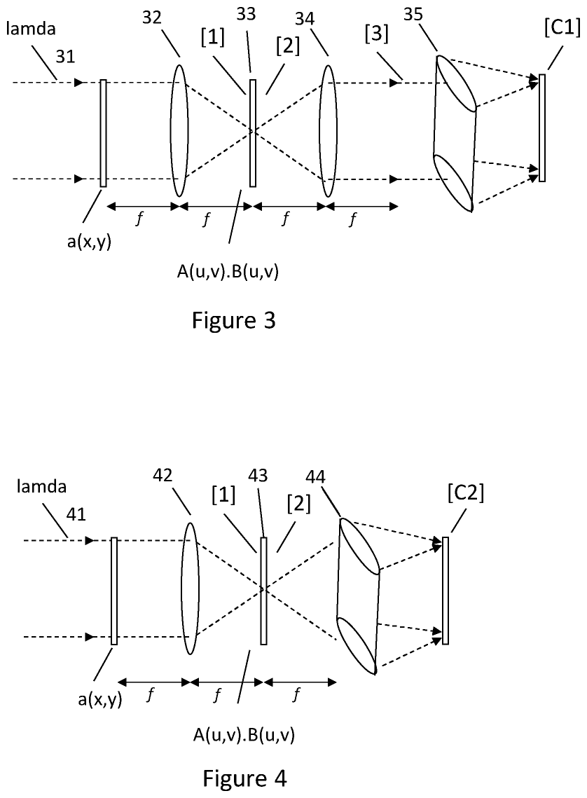

FIG. 3 shows a suitable embodiment of the optical system described in FIG. 1 above. Here, a coherent, collimated wavelength of light 31 lambda is used as the processing medium. The input data function a(x,y) is entered via phase, amplitude, or complex modulation of the laser beam. This has been previously shown in the patents above to be realized by, but not limited to, passing the beam through a liquid crystal layer in a Liquid Crystal on Silicon Spatial Light Modulator (LCoS), or through a succession of 1-dimensional waveguides routed into a two-dimensional grid in silicon photonics, before being projected through a Fourier transforming lens 32. It is well known in the field that if the input function is positioned at the front focal plane of the lens, of focal length f then its equivalent Fourier transform function will form at the rear focal plane of the lens 33. By modulating the light at the rear focal plane via phase, amplitude or a combination of both, then the Fourier transform A(u,v) (where A(u,v) is the two dimensional Fourier transform of a(x,y); x,y are spatial co-ordinates; u,v are spatial frequency co-ordinates) may be element-wise multiplied by a further function B(u,v) 33. In the case of FIG. 3, the multiplied function is then optionally inverse Fourier transformed by lens 34, before the rows are summed optically by focusing the light through cylindrical lens 35. A sensor such as a pixelated CMOS sensor or photodiode array (or other suitable method) may be used to capture the resulting light intensity at point [C1] on FIG. 1.

FIG. 4 shows the embodiment described in FIG. 2. Here, the optical function is not inversely Fourier transformed and instead the Fourier transform information is captured by the sensor array positioned at [C2]. Here, the coherent light 41 of wavelength lambda is modulated through input function a(x,y) as before and is Fourier transformed by lens 42 and element-wise multiplied by the function B(u,v) 43. The light then passes through cylindrical lens 44 to be summed optically and captured by the sensor array at position [C2]. One benefit of using the inverse Fourier transform stage is that the electronically captured is retrieved in the spatial domain rather than the frequency domain, which means there is no central undiffracted “DC” term which may cause saturation or obscure neighbouring pixel data. The element-wise multiplication may also be performed electronically without the need for the optical multiplication to be included.

Other embodiments based on those shown in FIGS. 3 and 4 allow the optical information to be captured at earlier stages of the optical path, denoted by [1], [2], [3], so that the multiplication and/or summation stages may be performed electronically, rather than optically. This gives some flexibility on the complexity of the optical system and the driving of the electro-optics modulators.

The SWIFFT2D algorithm will now be compared with the SHA-256 algorithm currently used for bitcoin mining.

In a single SHA-256 iteration, there are around 3000 integer operations that need to be calculated sequentially: a x86 computer would have about that many instructions per hash. The security of the SHA-256 algorithm has not been proven however it has been implemented for several years now without a known vulnerability. Having said that, the SHA1 family of algorithms was thought to be secure and was subsequently shown to be not as strong as the length of the output implied.

SWIFFT2D is part of a family of provably secure hashing functions known to be NP-hard to find collisions, and thought to be unbreakable even with the advent on quantum computing. The downside of computing SWIFFT in the traditional form is the cost of the FT operations. On an optical device with high enough precision, the output of a hash function can be obtained synchronously with the optical frame rate, requiring only a lookup table on either side of the device. Even in a bad case of a low precision device e.g. a device with 4-bit readable output, we are able to obtain the result in 4 optical frames. Each element of the output vector requires a reduce-sum operation over 4 integers with a single integer modulo operation, all of which can be calculated independently in parallel.

Taking the comparison between the two algorithms into account, it is clear that an optical device calculating SWIFFT2D could be much faster than even specialised ASIC hardware calculating SHA-256. The power consumption of the optical system is also significantly lower. These two factors coupled with the improved security features of the algorithm mean that SWIFFT2D implemented on optical hardware is a completely viable improvement vs.

SHA-256.

Whilst the methodology of embodiments of the invention may be employed generally for hashing applications, specific implementations may be, for example, in the context of video processing, blockchain, and cryptocurrency mining.

1. A hashing method comprising the steps of:
converting an input message into a binary input matrix with columns and rows;
multiplying the binary matrix with an integer specific to each row;
applying a Fourier Transform (FT) to obtain Fourier coefficients; wherein the FT is an optical FT; and
applying a linear combination across the rows.

2. The hashing method according to claim 1, wherein the optical FT is a 2D optical FT which calculates a matrix of Fourier coefficients.

3. The hashing method according to claim 2, further comprising the step of applying an element wise matrix multiplication in the Fourier domain with an additional matrix of the same size.

4. The hashing method according to claim 1, further comprising the step of applying an optical Inverse Fourier Transform (IFT) before the step of applying a linear combination across rows.

5. The hashing method according to claim 1, wherein the step of applying a linear combination is optical.

6. The hashing method according to claim 1, wherein the steps of converting and multiplication of matrix elements are realised electronically prior to any optical processing.

7. The hashing method according to claim 6, wherein a look-up table is employed in the multiplication of matrix elements.

8. The hashing method according to claim 1, wherein each column of the matrix is fed in parallel to a single free-space optical FT in order to provide outputs from the optical FT.

9. The hashing method according to claim 8, wherein the outputs are fed into an array of waveguides to represent vectors of Fourier coefficients.

10. The hashing method according to claim 9, further comprising the step of re-stitching the vectors of the Fourier coefficients into columns of a further 2D matrix with columns and rows.

11. The hashing method according to claim 10, further comprising the step of multiplying each row of the further 2D matrix optically, element-wise against a pre-determined vector.

12. The hashing method according to claim 11, further comprising the step of summing across the rows by optical combination of the waveguides that make up each row of the 2D matrix into a single optical signal.

13. The hashing method according to claim 12, further comprising the step of realising the electronic conversion of optical output signals to a modulo p answer via the use of a look-up table.

14. The hashing method according to claim 1, further comprising the step of normalising the optical outputs by rendering the highest value in the output equal to the highest value in the bit range and applying linear scaling over the other values.

15. The hashing method according to claim 12, further comprising the step of realising the electronic conversion of optical output signals to a modulo p answer via the use of an electronic modulo operation.

16. The hashing method according to claim 1, comprising the step of obtaining arbitrary precision on a precision limited machine using multiple passes and post processing of partial outputs.

17. A processing system comprising an electronic processor configured to convert an input message into an integer matrix with columns and rows, and an optical processor configured to calculate a Fourier Transform (FT) to obtain a matrix of Fourier coefficients; wherein the FT is an optical FT; the optical processor being further configured to apply a linear combination across the rows.

18. A processing system comprising an electronic processor and an optical processor configured to carry out the hashing method of claim 1.
